(19) United States
(12) Patent Application Publication
(10) Pub. No.: US 2009/0241082 A1
(43) Pub. Date: Sep. 24, 2009

(54) Method and System for Generating an Accurate Physical Realization for an Integrated Circuit Having Incomplete Physical Constraints

(76) Inventors: Michael D. Amundson, Oronoco, MN (US); David A. Lawson, Rochester, MN (US); Brian C. Wilson, Rochester, MN (US)

Correspondence Address: IBM-Rochester c/o Toler Law Group, 8500 Bluffstone Cove, Suite A201, Austin, TX, 78759, US

(21) Appl. No.: 12/051,440

(22) Filed: Mar. 19, 2008

(51) Int. Cl. G06F 17/50

(52) U.S. Cl. 716/8; 716/18

(57) ABSTRACT

A method, system and program product are described for implementing an integrated circuit. Synthesis tools and a continuum of physical constraints are used to generate a physical realization of a circuit from a hierarchy of logical circuits. Missing physical constraints are generated based on the behavior of the logical circuits, technology rules, timing constraints, and user controls. These constraints are refined throughout the process to produce an accurate physical realization. Generation of the physical constraints is user-controlled, allowing for a full continuum of input.

### FIELD OF THE INVENTION

The present invention relates generally to the design of integrated circuits, and more particularly, to running both logic and physical synthesis tools together with floorplanning information to generate a physical synthesis of an integrated circuit.

### BACKGROUND OF THE INVENTION

Modern integrated circuit design relies heavily on the use of various software tools that perform the tasks required to implement a desired circuit design. In general, a traditional design process involves creating a high level description of a design to create a logic netlist for the circuit being designed. The high level description may include register points, flip flops and other components, and is created using a description language such as VHDL or Verilog. This process results in a design data file known as a Register Transfer Level (RTL) netlist. The netlist is typically processed by two categories of tools. The tools are used to test the design and convert the netlist into other computer readable files needed to actually fabricate a circuit.

The first category of tools used to process the netlist includes functional design and verification tools. These tools are used to test a circuit's logic performance, i.e., whether the circuit generates the desired output signals in response to a pre-defined set of input signals. The functional design and verification tools are typically software implemented processes that are run on a workstation or other processor. The tools use the netlist file to create a software model of the definitional design, i.e., the RTL design. A variety of simulated inputs may then be applied to the software model. The resulting outputs of the model are recorded and compared to expected outputs to determine whether the definitional design produces the logic results required.

The second category of tools used to process the netlist includes synthesis and implementation tools. Synthesis and implementation tools are typically implemented in software that also runs on a workstation or other processor. The tools are highly technology dependent and are used to create an implementation of the circuit components onto a microchip. More specifically, logic synthesis tools are used to generate a mapped logic netlist, which contains a description of the gates and interconnections between gates for a desired circuit.

The resultant design then proceeds to a layout process. More particularly, the mapped logic netlist is provided to a placement tool. The placement tool determines where the gates of the circuit will be physically located. The tool determines where the gates will be placed within an “image” that has been pre-designated to contain the circuit, wherein the “image” is a file or in-core representation of the physical outline, port locations, circuit rows, blockages and so forth of the circuit. Physical designers measure timing based on estimated wire delays. For this purpose, designers may use methods well known in the art, such as the Steiner estimation. The physical designers also resolve timing and congestion problems using a variety of known optimization tools and manual changes until the estimated timing and placement of components appear acceptable. Thus, the typical process of designing an integrated circuit involves running both logic and physical synthesis.

The two steps, as noted, are generally confined to separate parts of the process. Logic synthesis is run without physical design information. The design data, i.e., the design logic netlist, is delivered to the physical design engineer. The engineer then begins the physical implementation, which includes executing physical synthesis.

As newer Complementary Metal Oxide Semiconductor (CMOS) technologies emerge, the time spent in physical design has increased. The increased time requirements associated with such increasingly complex technologies has negatively impacted design schedules, and consequently, gross revenues and profits. Moreover, the modeling of wire delay in logic synthesis has changed over time since wire delay has become more dominant in the overall design of a timing path. The best models are rough predictions of real physical effects. Logic synthesis may make important decisions based on silicon and wire information, but these decisions may not be optimum from a physical design perspective, e.g., shattering complex gates, cloning versus buffering, etc. This, in turn, may make timing closure much harder in physical design.

The disconnect between logic and physical synthesis is a known problem within the semiconductor/electronic design automation (EDA) industry. Design application companies, such as Synopsys, Cadence, and Magma have developed tools such as, Synopsys Design Compiler Topographical, which provide some physical design information to the logic synthesis tool. As a result, decisions made in logic synthesis may correlate to those in physical design. Further, industry RTL-to-placed-gates tools also exist to assist the process. However, the currently existing solutions are deficient in numerous ways.

More specifically, some solutions do not perform a “real” physical synthesis in the logic domain. Further, current solutions assign signal ports on the periphery of a macro being created. This can wreak havoc on global routing at the microchip level. While large objects can be fixed placed, object locations must be represented in absolute coordinates. Representation of locations and absolute coordinates requires that the size of the macro must already be known. In addition, choosing a specific location takes extra effort and fixing an object to a specific location may be a bad choice resulting in poor results.

Full function RTL-to-placed-gates solutions exist, such as Placement Driven Synthesis (PDS) from International Business Machines Corporation (IBM), but such solutions may still require significant physical design resources to predefine accurate physical constraints to obtain meaningful results, wherein “physical constraints” is information which defines the image and pre-placed gate locations. While there currently exist mechanisms for automatically generating floorplan information, the generated physical constraints are not accurate.

For the above reasons, what is needed is a method to easily generate accurate physical constraints when they are missing. This information can be used within physical synthesis to produce a high quality physical realization early in the design process, wherein “physical realization” consists of a logic netlist, image and placed netlist, and wherein a “placed netlist” is a file or in-core representation of the gate locations within the circuit.

In this application, the following terms shall have the meanings set forth herein.

A “logical circuit/netlist” is a file or in-core representation of the logic gates and interconnects in a circuit being designed.

An “image” is a file or in-core representation of the physical outline, port locations, circuit rows, blockages and so forth of a circuit being designed.

A “placed circuit/netlist” is a file or in-core representation of gate locations within the circuit.

“Physical constraints” is information which defines the image and pre-placed gate locations.

A “physical realization” is a file(s) or in-core representation which fully defines the circuit for subsequent physical design steps, i.e., logical netlist, image and placed netlist.

### SUMMARY OF THE INVENTION

The present invention provides a synthesis tool with automated floorplanning techniques for designing an integrated circuit. A continuum of physical constraints is input to perform a physical synthesis comparable to that done by a physical design engineer.

Physical synthesis requires a logic netlist. The logic netlist can be an RTL netlist or a full synthesis logic netlist. If the input is an RTL netlist, logic synthesis must be performed prior to physical constraint generation; this may be done as part of the synthesis tool. Missing physical constraints are generated automatically based on the behavior of the logic netlist. These constraints are accurate with respect to the circuit being processed. Missing physical constraints may include image dimensions and port locations. A physical realization of the circuit is then generated based on the complete physical constraints. The constraints may be refined throughout the process as the state of the circuit changes.

More specifically physical constraints are generated. Components are placed based on the physical constraints. At least one of a logical circuit, physical circuit and physical constraints for the circuit is generated.

In a more specific aspect, the user provides image dimension or aspect ratio rough box placement, and rough port assignment information to further refine the generated physical constraints and thus further improve the accuracy of the physical realization of the circuit. This information is accessed via a user control file. A physical realization of the circuit is generated based on the logic net list, technology rules, timing constraints and user controls.

In another embodiment, a computer system for generating a circuit is provided. The computer system includes a computer, processor and storage medium. First code is provided on the medium for receiving information for a circuit being designed and for generating physical constraints for the circuit being designed. This information may be in the form of a logic netlist which can be an RTL netlist, or a full synthesis logic netlist. Second code is provided for using the physical constraints for placing components. Third code generates at least one of the logical circuit, physical circuit and physical constraints for the circuit.

In another embodiment, a computer readable program product stored on a computer readable medium is also provided. The computer readable program product is configured to perform the steps of generating physical constraints for a circuit being designed. The physical constraints may be generated from a logic netlist which can be an RTL netlist for a circuit being designed, or it can be a fully synthesized logic netlist. Second code in the program product also places components.

These and other advantages and features that characterize the invention are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments of the invention.

### BRIEF DESCRIPTION OF THE DRAWINGS

FIG. 1 is a schematic diagram illustrating the general environment in which the underlying principles of the present invention may be implemented.

FIG. 2 is a diagram illustrating the full continuum of circuit synthesis possible with the invention.

FIG. 3 is a flow diagram illustrating implementation of the invention.

FIG. 4 is a diagram illustrating rough box placement in an exemplary manner.

### DETAILED DESCRIPTION

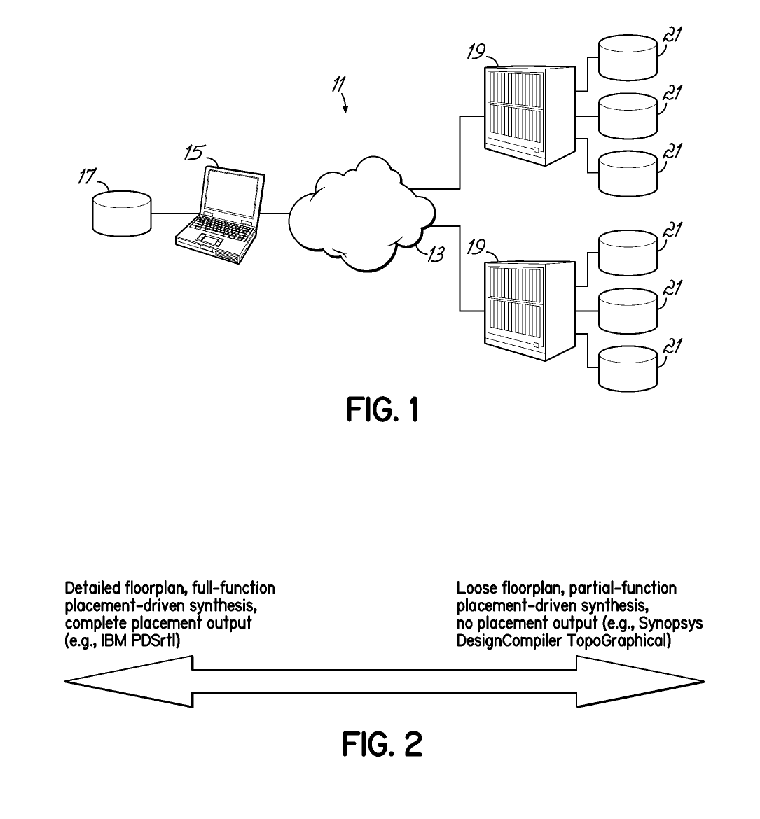

FIG. 1 shows a general environment 11 in which embodiments of the invention may be implemented. While general environment 11 is shown having a specific configuration, it will be appreciated that implementation of the invention is not limited to such an arrangement and aspects of the invention may be implemented in various alternative implementations of computer systems and devices.

In one exemplary configuration, a general environment 11 for implementing the invention includes a network 13 having as a part thereof at least one user terminal 15, such as a personal computer, which is optionally connected to separate databases 17 arranged in a conventional storage medium. Also connected to the network 13 may be larger computer systems, such as servers 19, which are also optionally connected to, in one example, a plurality of additional databases 21. The databases 21 may be stored on conventional storage devices. The synthesis tools implemented in embodiments of the invention may reside in any one of the various storage components and/or devices that are part of the network 13. While design of circuits in accordance with aspects of the invention may be done in batch processing, it will be apparent that various aspects may also be done interactively, in parallel or otherwise, and implemented on different systems, such as shown in FIG. 1.

In providing a merged logic and physical synthesis tool in accordance with the invention, reference is made to two specific IBM tools known as BooleDozer and PDS. These tools respectively represent typical logic and physical synthesis technologies that may be implemented as a merged tool combined with automated floorplanning techniques.

The IBM EDA tool known as BooleDozer is a tool that provides logic synthesis. Logic synthesis is a process that compiles an RTL description into an optimized technology-specific network implementation. Logic synthesis requires a description of a target technology in which the design is to be implemented. Information that is part of the description includes physical information, such as size and delay of gates, and functional information such as logic equations for gates. Such systems are well known to those of ordinary skill in the art, and are readily available from a number of different vendors such as IBM, Synopsys, Cadence and Magma.

IBM's PDS is exemplary of a physical synthesis tool that is used by chip designers involved in the design closure of digital circuits. More specifically, such a tool provides placement-driven synthesis to deliver an optimized physical netlist upon completion.

As illustrated in FIG. 2, the merged tool in accordance with aspects of the invention provides support across the broad range of design, including at one end where a loose floorplan, partial function placement driven synthesis is provided to the design tool with no placement output. Such information may be derived, for example, from the use of a design program known as Design Compiler Topographical available from Synopsys. At the other end of the spectrum, a detailed floorplan, full function placement driven synthesis, and complete placement output may be provided, such as that which results from IBM's PDS tool.

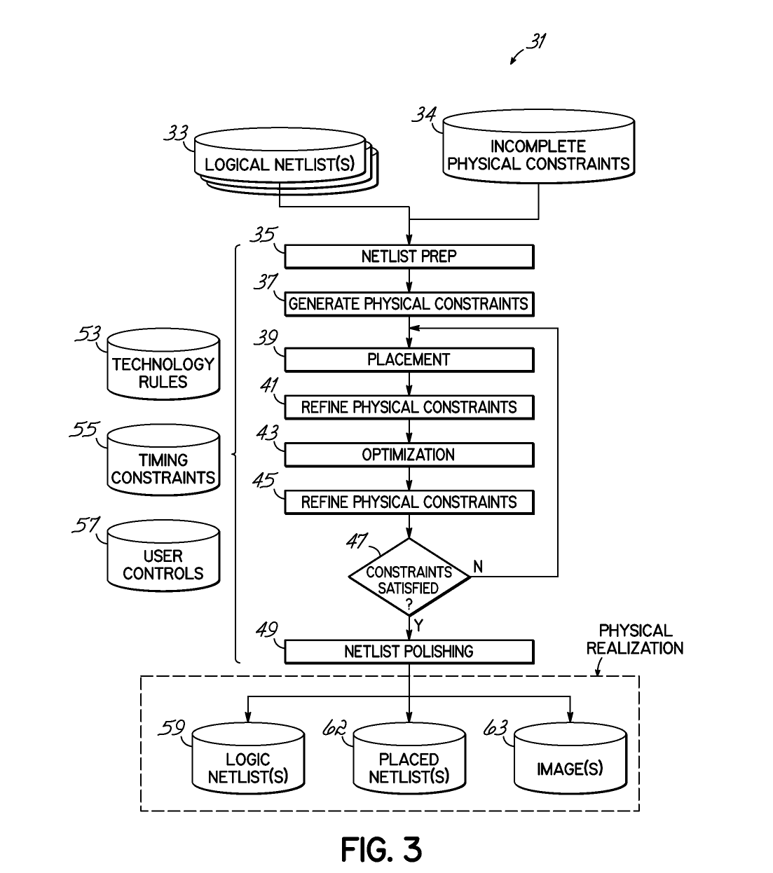

The embodiment shown in FIG. 3 provides a merged logic and physical synthesis tool employing automated floorplanning techniques to perform early logic restructuring and technology mapping in the logic domain, which then switches to the physical domain for timing optimization. A complete continuum of floorplanning information may be input into the tool. The physical optimization uses placement-driven synthesis technology. The optimization may provide the same physical synthesis comparable to that done by a physical design engineer.

Although, implementation of the invention has been described using tools such as IBM BooleDozer and PDS, the embodiments are not limited to such tools and may be implemented as a merger and modification of a multitude of other different tools commercially available from different vendors. This combination with automated access to floorplanning information provides an output that contains both the logic netlist and physical design information. Such data can be input directly into the physical design process providing enhanced correlation and reducing overall turn-around time in physical design. Timing paths are recognized early and implemented correctly.

Signal ports can be placed in a variety of ways. More specifically, in an exemplary embodiment, choosing an interior assignment for the ports will produce a near-minimum wiring solution without causing port placement to adversely affect box placement. The port locations are chosen after the box is placed. The interior assignment method provides relief for top-level wire routing. Since ports are not restricted to an edge assignment, a variety of paths can be chosen with equivalent wire length, but with reduced overall congestion.

In addition, rough box placement capability is provided. The system allows the user to hint where an object should reside without having to know the size or shape of the macro. Using a rough box placement minimizes user error since a rough placement is only a hint. The tool is free to move the box to a more correct location if needed in accordance with predetermined rules. The tool accepts a continuum of physical design input. The tool allows for macro size and ports to be resized and reassigned at specific points during the design run. Thus, an accurate physical realization is achievable with embodiments of the invention.

FIG. 3 illustrates aspects of the invention in greater detail. More specifically, a flow diagram 31 includes a first set of design information that is input as logical information 33 with or without physical circuit information with incomplete physical constraints 34. The logical circuit information 33 can be a human generated logic netlist such as RTL information or a logic netlist generated from the RTL information by a synthesis tool. At step 35 a complete logic synthesis is conducted through input of technology rules database 53, user constraints database 55 and user controls database 57.

The invention included accessing the technology rules database 53, user constraints database 55 and user controls database to specify an aspect ratio for the dimensions of the circuit. The physical dimensions may also be specified.

At placement step 39, rough placement information for ports and sub-circuits may be generated. Further, as will be apparent, through an iterative process, explicit physical locations for ports and sub-circuits may be generated.

All of these steps are conducted as part of the flow of FIG. 3 as implemented on systems represented in exemplary form by a system such as shown in FIG. 1, and with a computer program product including code on storage medium.

The pseudo code which follows is illustrative of implementation of all the steps of FIG. 3.

```
import_user_controls( )
import_rules( )
import_logical_circuits( )
import_physical_constraints( )
import_user_constraints( )
prepare_netlists( )
if ( physical_constraints_are_incomplete( ) )
  generate_physical_constraints( )
i = 0
until ( i >= max_iterations || constraints_satisfied( ) ) {
  do_placement( )
  if ( refine_physical_constraints_after(get_current_step( )) )
    refine_physical_constraints( )
  do_optimization( )
  if ( refine_physical_constraints_after(get_current_step( )) )
    refine_physical_constraints( )
  i++
}
polish_netlists( )
export_logical_circuits( )
if ( save_physical_constraints )
  export_physical_constraints( )
if ( save_physical_circuits )
  export_physical_circuits( )
exit
```

With respect to generation of physical constraints in step 37 of FIG. 3 the following pseudo-code illustrates the step 37 in greater detail in an exemplary manner.

```
  foreach circuit (
all_logical_circuits_in_hierarchy(depth_first_search) ) {
    # Create dimensions?
    if ( create_dimensions(circuit) ) {
        aspect_ratio = get_user_aspect_ratio(circuit)
        if ( aspect_ratio ) {
          create_dimensions_based_on_logical_circuit_using_{—}
aspect_ratio(circuit, aspect_ratio )
        } else {
          create_dimensions_based_on_logical_circuit_with_{—}
padding(circuit, large_padding )
        }
        create_circuit_rows_for_placement( circuit )
        create_highest_wiring_layer( circuit )
      } else {
        # Assign ports to pre-defined physical location
        foreach port ( get_preplaced_ports(circuit) ) {
          force_port_to_location( box, get_port_location(port) )
        }
        # Assign boxes to pre-defined physical location
        foreach box ( get_preplaced_boxes(circuit) ) {
          force_box_to_location( box, get_box_location(box) )
        }
      }
      # Attract ports
      foreach port ( get_ports_with_physical_region(circuit) ) {
        attract_port_to_region( port, get_region_from_port(port) )
      }
      # existing port assignment algorithms may assign ports to an edge,
to the interior, and so forth
      assigin_ports( circuit, algorithm )
      # Attract Boxes
      foreach box ( get_boxes_with_physical_region(circuit) ) {
        attract_box_to_region( box, get_region_from_box(box) )
      }
```

At step 39 components for the circuit are placed based on the physical constraints generated. At step 41 the physical constraints are refined as illustrated in an exemplary manner in the pseudo code set forth below.

```
  foreach circuit (
all_logical_circuits_in_hierarchy(depth_first_search) ) {
    # Resize dimensions?
    if ( allow_resize(circuit) ) {
      # new size may go up or down depending on current area of
logical circuit
      aspect_ratio = get_user_aspect_ratio(circuit)
      if ( aspect_ratio ) {
        resize_dimensions_based_on_logical_circuit_using_{—}
aspect_ratio(circuit, aspect_ratio )
      } else {
        resize_dimensions_based_on_logical_circuit_with_padding(
circuit, padding )
      }
    }
    # Re-assign Port Locations
    foreach port ( get_ports_with_physical_region(circuit) ) {
      attract_port_to_region( port, get_region_from_port(port) )
    }
    assign_ports( circuit, algorithm )
    # Re-attract Boxes
    foreach box ( get_boxes_with_physical_region(circuit) ) {
      attract_box_to_region( box, get_region_from_box(box) )
    }
```

At step 43, the circuit being designed is optimized for timing, area power, congestion or to satisfy user constraints, as specified in technology rules database 53, timing constraints database 55, or based on user controls in database 57. At step 47, a check is made to ensure that constraints, for example, from databases 53, 55 and 57 have been satisfied. A resultant netlist is polished at step 49 through minor adjustments to result in a logical circuit 59, a physical circuit 62, and a set of physical constraints 63.

All three results 59, 62, 63 can be stored for later use in circuit design, or can be used in completing a circuit design through further processing or reuse in the flow of steps in FIG. 3.

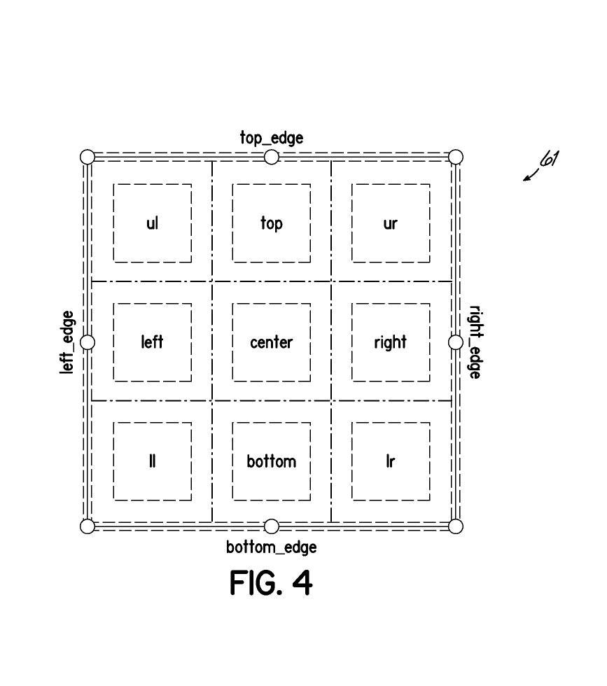

In implementing aspects of the invention, rough box placement 61 is obtained as illustrated in FIG. 4 by using placement attractions to pull a box into a user defined region. The set of regions is arbitrary, but a good choice may consist of nine equally sized regions for the macro. As shown in the figure, the macro includes upper left, top, upper right, left, center, right, lower left, bottom and lower right. The user need only suggest that an object be pulled to a region using the tool, instead of forcing a pre-placement. The method enhances flow by providing an accurate result with minimal user effort. Rough port assignment may be done in the same fashion. In addition, rough port assignment can support edges of the image (e.g., left_edge, right_edge, top_edge, bottom_edge).

In general, the routines executed to implement the illustrated embodiments of the invention, whether implemented as part of an operating system or a specific application, program, object, module or sequence of instructions, may be referred to herein as computer programs, algorithms, or program code. The computer programs typically comprise instructions that, when read and executed by one or more processors in the devices or systems in computer system, cause those devices or systems to perform the steps necessary to execute steps or elements embodying the various aspects of the invention.

Moreover, while embodiments of the invention have been described in the context of fully functioning computer systems, those skilled in the art will appreciate that the various embodiments of the invention are capable of being distributed as a program product in a variety of tangible forms. The invention applies equally regardless of the particular type of computer readable signal bearing media used to actually carry out the distribution. Examples of signal bearing media comprise, but are not limited to recordable type media and transmission type media. Examples of recordable type media include volatile and nonvolatile memory devices, floppy and other removable disks, hard disk drives, magnetic tape, and optical disks (CD-ROMs, DVDs, etc.). Examples of transmission type media include digital and analog communication links.

While the present invention has been illustrated by a description of various embodiments and while these embodiments have been described in considerable detail, it is not the intention of the Applicants' to restrict or in anyway limit the scope of the appended claims to such detail. For instance, while IBM tools have been described as merged to implement the invention, it is well known that there are other comparable tools available from other vendors such as Synopsys, Cadence and Magma which can be adapted and merged in a manner similar to that described herein. Thus, the invention is not limited to the IBM BooleDozer and PDS environments. The invention in its broader aspects is therefore not limited to the specific details, representative apparatus and methods, and illustrative example shown and described. Accordingly, departures may be made from such details without departing from the spirit or scope of Applicants' general inventive concept.

What is claimed is:

1. A method of designing circuits from incomplete physical constraints information, comprising:
generating physical constraints for a circuit being designed;
placing components of the circuit based on said physical constraints; and
generating at least one of a logical circuit, a physical circuit and physical constraints for a circuit.

2. The method of claim 1, further comprising accessing a database of technology rules and a database of timing constraints to generate said physical constraints.

3. The method of claim 1, further comprising specifying an aspect ratio of dimensions for the circuit being designed.

4. The method of claim 1, further comprising specifying physical dimensions for the circuit being designed.

5. The method of claim 1, further comprising generating rough placement information for ports which are part of the circuit being defined.

6. The method of claim 5, further comprising specifying explicit physical locations for ports for said circuit being designed in relation to a determined final physical dimension.

7. The method of claim 1, further comprising generating rough placement information for sub-circuits of the circuit being designed.

8. The method of claim 7, further comprising specifying explicit physical locations for sub-circuits of the circuit being designed.

9. The method of claim 1, further comprising iteratively refining the design of said circuit.

10. The method of claim 1, wherein the logical circuit is expressed as a hierarchy of logical circuits and incomplete physical constraints existing for at least some sub-circuit elements of a top-circuit being processed.

11. A computer system for generating a design for a circuit from incomplete physical constraints information, the computer system comprising:
at least one computer having at least one processor and storage medium;
first code on said storage medium for generating physical constraints for a circuit to be designed;
second code on said storage medium for generating information defining placement of components of a circuit being designed based on said generated physical constraints; and
third code for generating at least one of a logical circuit, a physical realization of a circuit and physical constraints for a circuit.

12. The computer system of claim 11 further comprising a logic netlist, a database of timing constraints and a database of technology rules for being processed with said first code for generating said physical constraints.

13. The computer system of claim 11, further comprising code for specifying an aspect ratio of the dimensions for the physical circuit being designed.

14. The computer system of claim 11 further comprising code for specifying the physical dimensions for the circuit being designed.

15. The computer system of claim 14, further comprising code for generating rough placement information for ports which are part of the circuit being designed.

16. The computer system of claim 14, further comprising code for specifying explicit physical locations for ports for said circuit being designed in relation to a determined final physical dimension.

17. The computer system of claim 11, further comprising code for specifying rough placement information for sub-circuits.

18. The computer system of claim 17, whenever said code for specifying rough placement information for sub-circuits is further adapted for specifying explicit physical locations for sub-circuits.

19. The computer system of claim 11, further comprising code for iteratively refining the design of said circuit.

20. A program product comprising:
program code configured for generating physical constraints for a circuit being designed and placing components of the circuit based on said physical constraints; and
a computer readable medium bearing the program code.
